(19) United States
(12) Patent Application Publication
(10) Pub. No.: US 2007/0095660 A1
(43) Pub. Date: May 3, 2007

(54) Sensor

(76) Inventor: Kevin F. Peters, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/263,786

(22) Filed: Oct. 31, 2005

(51) Int. Cl. G01N 27/26

(52) U.S. Cl. 204/400

(57) ABSTRACT

This disclosure describes chemically sensitive sensors and methods for fabricating them. At least one of these sensors may be fabricated having a channel housing that, when subject to an electric field, comprises an electrically active channel having a nanoscale cross-section dividing its length that is bounded by the channel housing's thickness and with an active width dependent on the electric field's strength.

### TECHNICAL FIELD

This invention relates to sensors and methods of fabricating sensors.

### BACKGROUND

Sensors, such as chemical-sensitive field-effect transistors (“ChemFETs”), may selectively detect chemicals in fluids. One way in which a ChemFET may detect a chemical is through adsorbing the chemical on a surface of the ChemFET. Adsorbing the chemical may cause a change in the electrical behavior of the ChemFET's electrical channel, which may be related to the presence of the chemical in the fluid. Some ChemFETs are capable, for instance, of selectively detecting cholesterol, proteins, nucleic acids, and antibodies in blood. Other specialty ChemFETs too are known as ISFETs and ENFETs which comprise an ion-sensitive membrane and enzyme-linked coating, respectively. Other partly related sensor devices employ a metallic gate electrode (MOSFET design) to adsorb a chemical over a wide metallic area and disperse the resultant chemical signal over a comparably wide area of the field effect transistor, so that good chemical signal averaging is obtained at the cost of lost sensitivity to small quantities of individually adsorbed chemicals.

Sensing a small quantity of a chemical in a fluid may be difficult for many ChemFETs. Sensing chemicals in a minute quantity of fluid may be difficult. Also, sensing numerous chemical species within a very compact area may be difficult. In part to address these problems, nanowire ChemFETs have been created, having nanometer-scale cross-sections and elongated lengths. These may be more sensitive to small quantities of individually adsorbed chemicals and may occupy a compact area. One of these nanowire ChemFETs has a chemically sensitive channel region that uses a fiber with a nanometer-scale cross-section (i.e., 1-100 nanometers). The fiber's nanometer-scale cross-section may enable the sensor to be sensitive to a small quantity of a chemical including such minute quantities as individual molecules or particles such as a virus. See, for example, F. Patolsky, G. Z., O. Hayden, M. Lakadamyali, X. Zhuang, C. M. Lieber. (2004) Electrical detection of single viruses. Procedings of the National Academy of Sciences of the U.S.A. (PNAS) 101, 14017-14022.]

But fabricating a nano-fiber ChemFET is often difficult and expensive. It may require creating a nano-fiber, coating it chemically, and disposing it on a surface for attachment to a source and drain region. Fabricating a large number of nano-fiber ChemFETs to be consistent may be particularly difficult which limits their usefulness. And these ChemFETs may be fragile and prone to errors due to their nano-fiber's tendency to break or detach.

To address some of these fabrication and usage problems, a relatively robust sensor has been fabricated using nanometer-scale patterning, such as with nanometer-scale photolithography, ebeam lithography, or nano-imprint lithography. This sensor may be less difficult to fabricate and have a channel region formed integral with or well-attached to an underlying layer or substrate, which may make it more physically robust than a nano-fiber channel region. Nanometer-scale patterning, however, can also be expensive. And the channel regions created with nanometer-scale patterning may be prone to surface flaws and a varying cross-section. Surface flaws and varying cross-sections may adversely affect a ChemFET's ability to accurately sense a chemical and may still limit their consistency and usefulness. Also, while often more robust than nano-fiber ChemFETs, ChemFETs with channel regions produced in this way may still be easily damaged because of their small cross-sections and generally small dimensions.

### BRIEF DESCRIPTION OF THE DRAWINGS

FIG. 1 illustrates perspective view of a semiconductive layer and a dielectric layer formed over a substrate.

FIG. 2 illustrates the layers shown in FIG. 1 after subsequent processing.

FIG. 3 illustrates the layers shown in FIG. 2 after subsequent processing.

FIG. 4 illustrates a cross-sectional view of an exemplary channel region bounded in part by an elongated sidewall oriented about perpendicular to a substrate.

FIG. 5 illustrates a cross-sectional view of an exemplary channel region bounded in part by an elongated sidewall oriented acutely to a substrate.

FIG. 6 illustrates a cross-sectional view of a channel housing having two elongated sidewalls over which one or more materials are applied.

FIG. 7 illustrates a perspective view showing exemplary source and drain regions.

FIG. 8 illustrates a perspective view showing a stack of exemplary channel housings.

FIG. 9 illustrates a top-plan view of an exemplary array of channel housings, source regions, and drain regions.

The same numbers are used throughout the disclosure and figures to reference like components and features.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail so as not to obscure claimed subject matter.

This document describes side-wall nanowires and sidewall nanowire ChemFET sensors and methods for fabricating them.

As used herein, “nanoscale” is the characteristic of having a dimension that is less than 1000 nanometers and greater than about 1nanometer. A “nanowire” is an elongate object that is nanoscale in two cross-sectional dimensions and elongate in a third dimension, the three dimensions being substantially orthogonal, and the nanoscale cross-section being the area that has some capacity to conduct electricity along at least a substantial portion of the elongate length.

In many embodiments of the present invention, at least a portion of a nanowire is semiconductive such that the capacity of the portion to conduct electricity may be altered by an electric field suitably applied to a surface of the nanowire, proximal to the portion. Semiconductive materials may include (but are not limited to) silicon, doped silicon, germanium, carbon nanotubes, diamond, gallium arsenide, cadmium sulfide, strained germanium, or a combination of any one of these with another material that together exhibit properties of a semiconductive material.

A “channel housing” is a material object having elongate length and width, nanoscale height, and also having a surface comprising at least a substantial portion of the nanoscale height and at least a substantial portion of the length. A “side wall” is said surface of a channel housing. In this case, the sidewall surface is nanoscale in a dimension substantially equivalent to the nanoscale height of the channel housing. The side wall may be or may not be inclined with respect to the height and length dimensions of the channel housing. In a non-limiting example, an inclined side wall corresponds to a crystallographic plane, such as the (111) plane of silicon.

A “side-wall nanowire” is a nanowire that comprises a nanoscale sidewall portion and a near-side-wall region (of the channel housing) that is nanoscale in depth from the side wall. The nanoscale depth of the near-side-wall region of the nanowire may be as much as about ten or tens of nanometers and is substantially less than the elongate width of the channel housing.

The side-wall nanowire may comprise, in certain embodiments, a deposited or chemically modified material that expressly provides for a semiconductive capacity to conduct electricity along the nanowire length. Non-limiting examples of a deposited side-wall nanowire material are chemical vapor-deposited doped germanium or doped silicon grown by selective epitaxy. A non-limiting example of a chemically modified side-wall nanowire material is silicon that has been diffusion-doped with boron from a spin glass.

The side-wall nanowire, in another embodiment, may comprise an electronically inverted or invert-able semiconductive material that expressly provides for a semiconductive capacity to conduct electricity along the nanowire length. Inversion is known to those skilled in the art of semiconductor physics to be the formation of a semiconductive skin of conducting particles (electrons or electron vacancies, of the opposite variety to what preceded them) near a semiconductor surface to which a suitable electric field has been applied. An inverted skin becomes conductive with these particles in a way that, prior to the electric field application, it was not. The inverted skin of conducting particles measures typically less than 5 nanometers and rarely more than 10 nm in depth from the surface. The same dimensional properties, it is to be understood here, are retained by an invert-able skin In the absence of the applied electric field as are afforded by an inverted skin under an applied electric field. A side-wall nanowire thusly formed according to the continuing embodiment may have a nanoscale side wall of 1 to 999 nm width corresponding to the channel housing thickness; a near-side-wall region of typically less than 5 nanometers depth, an elongate length, and some capacity to conduct electricity (semiconductively in many embodiments) through the nanoscale cross-section and along at least a portion of the length.

The channel housing may in some embodiments comprise, along substantial portions of its elongated length, width, and nanoscale height, an “electrically inactive region” in intimate contact with the sidewall nanowire. The electrically inactive region may be ineffective to conduct electricity along its length in a circuit that includes portions of a sidewall nanowire.

Embodiments effecting an incapacity to conduct electricity include the following non-limiting examples. The electrically inactive region may not include an inverted or invert-able region of the channel housing proximal a sidewall. The channel housing may comprise a second surface with a second dielectric coating of substantially great thickness or small dielectric constant so as to be ineffective to transmit an applied electric field. The conducting particles (electron vacancies or electrons) of the electrically inactive region may be the opposite variety of those of the side wall nanowire so as to have negligible capacity to conduct electricity in a circuit including points along the sidewall nanowire. The electrically inactive region may be provided with a paucity of conducting particles.

The ability (provided by the side wall nanowire) to conduct electricity along its length, semiconductively in some embodiments, may be useful for a number of purposes and it is to be understood that its embodiments are not to be limited to any particular purpose. By way of example, however, such ability may be useful in a side wall nanowire ChemFET sensor and its operation. This proposition is illustrated further, by way of non-limiting examples, in the next part of this discussion.

One type of sensor is a “ChemFET” or chemically sensitive field-effect transistor. A ChemFET comprises a transistor source region, a drain region, and, interposed between them in intimate electrical contact with each, a channel region of semiconductive material that is proximal a surface and is further coated with a dielectric material and a chemically sensitive material. Electrical conductance along the circuit from source to channel to drain relies on their having predominantly the same variety of conducting particle (electrons or holes) and so may in some embodiments require inversion of the channel region. A ChemFET is functionalized (with a chemically sensitive functional agent) to electrically respond to the presence of an analyte in a sample. Interaction between the functionalized ChemFET and the analyte may cause, for example, the generation of an electric field that, in turn, causes a detectable change in an electrical property of the ChemFET (e.g., a detectable shift in electrical conductance).

A “side-wall nanowire ChemFET sensor” is a ChemFET sensor comprising a side wall nanowire along which are disposed the source region, drain region, and particularly the channel region with dielectric and functional coatings.

In at least some embodiments, a sidewall nanowire ChemFET chemically sensitive sensor is fabricated from a nanoscale side wall that, when subject to an electric field, comprises an electronic channel having a nanometer-scale cross-section and that is further coated with dielectric and chemically functional layers that provide sensitivity to a target chemical species in a fluid. The nanoscale ChemFET has a channel having cross-sectional area that is bounded in one dimension by the channel housing's nanoscale thickness and in the dimension orthogonal to the surface by the nanoscale width of an electron inversion layer (“active width). with an active width dependent on the electric field's strength but not the channel housing's width. This sensor may, in some cases, be relatively robust by comprising a channel housing that has a cross-section with a micron or larger dimension while permitting an electrical channel within it that has a cross-section with only nanometer-scale dimensions and provides superior sensing, i.e., at small concentrations, of minute sample quantities, and within a compact area.

Methods for fabricating a channel housing are also described. Using one of these methods, a sensor permitting an electrically active channel having a nanometer-scale cross-section may be fabricated using conventional rather than nanometer-scale patterning. By so doing, a sensor may be fabricated at a lower cost and with better precision than often permitted when using nanometer-scale patterning. Using an additional fabrication method, an electrically active channel having a nearly defect-free surface may be fabricated. By so doing, a sensor may be fabricated capable of better performance than one having a defective surface.

Fabricating a Channel Housing

Referring to FIG. 1, a semiconductive layer 102 and a dielectric layer 104 are shown formed over or from a substrate 106. The semiconductive layer has a thickness between about one to about one hundred nanometers. In the illustrated embodiment, the semiconductive layer comprises doped silicon with a thickness of about thirty nanometers (marked at “T”). The doping level is generally about 10¹⁶ to 10²⁰ per cubic centimeter and is chosen and fabricated so that the semiconductive layer is able to undergo a semiconductor device mechanism known as inversion when an external electrical bias of suitable strength is applied. P⁺and N⁻doped regions are shown in FIG. 1 and marked at 108 for P⁺and 110 for N⁻. Another P⁺region is at the opposite end (not shown) from the P⁺region shown in FIG. 1 at 108. The dashed line marks the bounds of region 108 under layer 104. The dielectric layer resides over the semiconductive layer effective to electrically isolate a surface (e.g., the top) of the semiconductive layer from the effects of chemicals or electrical fields. The dielectric layer may comprise silicon dioxide, silicon nitride, and polymeric dielectric materials. The semiconductive layer may also be isolated from the underlying substrate by an isolation layer 112. In the illustrated embodiment, the substrate comprises a silicon-on-insulator substrate with a silicon dioxide isolation layer on thick supportive silicon. In another embodiment, the isolation layer comprises doped silicon that can be fabricated upon a substrate by using standard practices, such as ion implantation, chemical vapor deposition, or epitaxial growth.

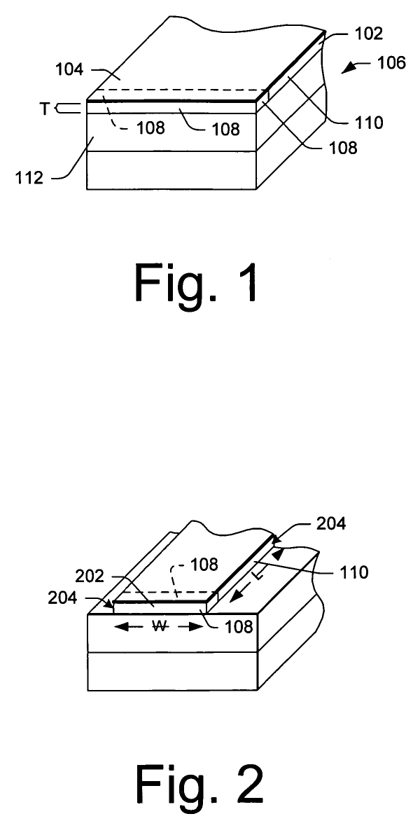

Referring to FIG. 2, the semiconductive layer and the dielectric layer are patterned effective to create a channel housing 202 having one or more elongated sidewalls 204. With relatively large-scale patterning, such as micrometer and larger scale photolithography or other suitable techniques, the channel housing may be formed having an elongated source-drain separation length (marked at “L”) and a width (marked at “W”) that are micrometer or larger. The length L is bounded by regions 108 (one of which is shown). Nanometer-scale patterning may also be used, effective to form the channel housing with a length and/or width that is sub-micrometer in scale. The channel housing may be relatively robust by having a micrometer or larger width and/or by being sandwiched between protective layers, such as the dielectric layer and the substrate. The elongated sidewalls are thereby established capable of having elongated lengths and nanoscale thicknesses.

Also in the illustrated embodiment, the patterning is effective to fabricate the channel housing having a length of about 100 microns and a width of about sixty microns. The figures are not to scale. The semiconductive layer and the dielectric layer may also be patterned effective to create an array of channel housings, an example of which is described later below.

The elongated sidewalls are exposed and so may be available for later processing to enable the elongated sidewalls to sense chemical(s) in a fluid. Other surfaces of the channel housing, such as a top surface in contact with the dielectric layer and a bottom surface in contact with the substrate, may be left unavailable for later processing or chemical sensing. Also, the top surface may remain electrically isolated by the dielectric layer due to the dielectric layer's low capacitance. Further processing to enable the elongated sidewalls to sense chemicals is described in greater detail below.

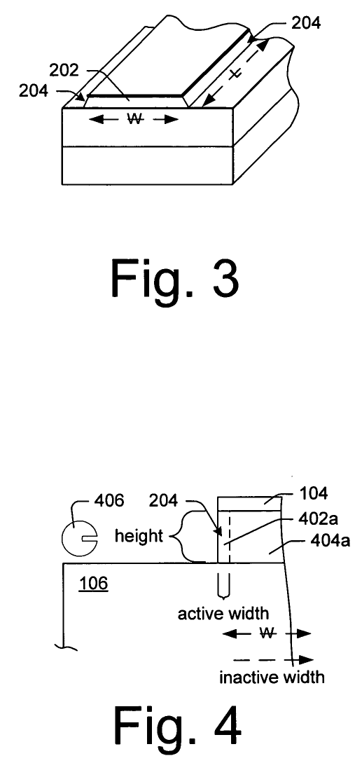

Referring to FIG. 3, elongated sidewalls 204 are chemically etched. This etching may be effective to create generally planar surfaces along each of the elongated sidewalls. These surfaces may have very few defects and be extremely smooth. They may also be nearly perfectly planar. Note that region 108 is not shown; FIG. 3 shows a cross section along the boundary shown in FIG. 2 between region 108 and 110. FIGS. 4-6 and 8 also show a cross section along this boundary.

Continuing the illustrated embodiment, a chemical etchant, such as potassium hydroxide (KOH) is used to create [111] crystal planes from the doped silicon of the channel housing at the elongated sidewalls. By so doing, the surface of the elongated sidewalls may have a nearly perfect surface, which may reduce sensor variability, increase sensitivity, and/or enable other desirable properties for a sensor having these elongated sidewalls. The surface of each elongated sidewall is shown in FIG. 3 oriented acutely relative the substrate and obtusely relative the dielectric layer.

Sidewalls fabricated as illustrated in FIG. 2 or FIG. 3 can be more effective as sensors when the elongated sidewall's semiconductive material is passivated and insulated by a thin layer of non-conducting material that has the capacity to transmit an external electrical field to the semiconductive sidewall. This layer, herein called a sidewall gate dielectric, may perform the same function as a gate dielectric known in standard MOSFET devices. The sidewall gate dielectric can be thermally grown silicon oxide of a few nanometers thickness and/or a second material, such as silicon nitride. A particularly effective sidewall gate dielectric layer may be thermally grown oxide on the nearly perfect surface of chemically etched [111] sidewalls. Other sidewall gate dielectric materials and combinations thereof may be suitable, including oxides of other semiconductors, covalently attached organic compounds, high-dielectric-constant perovskites, and the like. The sidewall gate dielectric layer may also serve to attach additional functional sidewall layers that provide chemical sensing functions.

Semiconductive layer 102 of FIG. 1 (or channel housing 202) is processed such that its exposed elongated sidewall may be made into an active channel region. An active channel region is conductive between a source and drain region or contacts when in the presence of a suitable external electric field and is non-conductive without such a field. One way in which to do so is to heavily dope (P+ or N+) source and drain contacts and to dope (N or P, respectively) the silicon active channel region such that, by applying an electric field to the surface, the material in the active channel region may be made conductive or barely conductive between the source and drain regions, inclusively. Then, when in the presence of particular molecules desired to be analyzed, the charge or lack of charge on the molecules may affect the electrical field and thereby the behavior (e.g., conductivity) of a portion of the active channel (e.g., near the particular molecules on the elongated sidewalls). This change in electrical behavior may be measured, indicating the presence of the molecules.

The volume of the channel housing that may be made sensitive to small changes in an electric field is confined to a near-surface region of no more than about 10 nanometers of thickness of inverted and thus conductive material along the sidewall. The volume may depend on the electrical isolation afforded the channel housing by dielectric layer 104. The dielectric layer 104, in one embodiment, is a low-dielectric-constant material of substantial thickness such as to exhibit very low capacitance and accordingly a poor capability to transmit electric field to the semiconductive material from external sources. This dielectric layer may permit only a region very near the elongated sidewalls to be made conductive between source and drain or to be made chemically sensitive. Thus, a surface (e.g., the top) proximate this dielectric layer may be substantially incapable of enabling alteration of a height or active width of an electrically active channel region through alteration of an electric field's strength. With an appropriate electric field, a channel region that is sensitive to small electric-field changes may be created near an elongated sidewall.

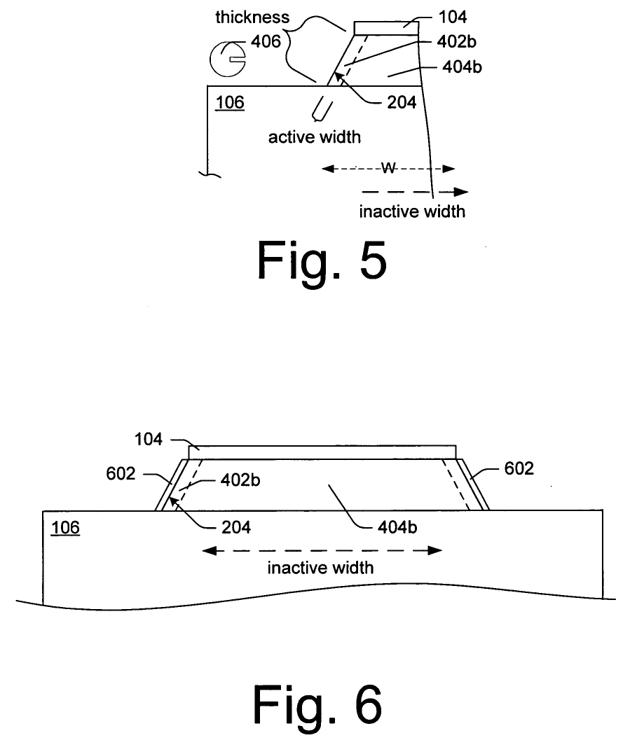

Referring to FIGS. 4 and 5, respectively, active channel regions 402a and 402b are shown in cross-section. In one embodiment, the active channel region 402a/402b each represent an inversion layer that is generated by application of a suitable electric field that is applied to the sidewall 204. In FIG. 4, the channel region shown is bounded in part by an elongated sidewall 204 that is about perpendicular relative to substrate 106 and dielectric layer 104. In FIG. 5, the channel region shown is bounded in part by an elongated sidewall 204 that is oriented acutely relative the substrate and comprises a surface having a [111] silicon crystal plane.

Each of these active channel regions is capable of becoming electrically sensitive to small particles and small electric field changes when subject to an appropriate electric field. These channel regions are shown in cross-section to display electrically active cross-sections dividing the channel region's (and the channel housing's) length. Electrically inactive regions are also shown and marked at 404a and 404b. These inactive regions are bounded by 402a or 402b (respectively), 106, and 104, and have electrically inactive regions having an electrically inactive width. The cross-section of channel region 402a, for instance, has a height bounded by the channel housing's thickness. Where that thickness may be approximately 30 nanometers, for example, it is substantially as small as a virus, an antibody, or like-sized particles 406. It may also be as small as a semiconductor depletion length. One practiced in the art may readily recognize this nanoscale size matching as a source of the extraordinary sensitivity of nanoscale chemically sensitive field-effect-transistors to small particles. The cross-section of channel region 402b, for instance, has a height dependent on the thickness of the channel housing and the angle of the elongated sidewall. In both cases, the cross-sectional area of the channel regions is shown at about 300 to about 350 square nanometers. The illustrated channel housing 202, however, is shown with a cross-sectional area of many thousands of square nanometers, though it can be many millions in some embodiments. Channel regions 402a and 402b also have an electrically active width that depends on the strength of an electric field, which is shown at about one to five nanometers. Note also that the width of the channel housing in the illustrated embodiments of FIGS. 4 and 5 (shown at “W”) is many times that of the active width of the channel region, as may be the electrically inactive width of the electrically inactive region 404.

The length and height of the channel regions 402a and 402b, however, may be fabricated to a wide range of sizes. Thus, the channel regions may be many microns long and hundreds or more nanometers in height, but have nanometer-scale active widths. The channel housings can be fabricated at significantly lower cost than nanoscale patterning and yet provide active channel regions enabling nanoscale sensors. As the active channels are elongated in one dimension, are nanoscale in a second physical cross-sectional dimension, and are electronically nanoscale in the third dimension, the active channels may comprise an effective nanowire for certain purposes such as sensing and yet may be fabricated by entirely conventional means as described herein.

Referring to FIG. 6, one or more materials 602 are applied as coatings on elongated sidewalls 204's surfaces or sidewall gate dielectrics surfaces, effective to enable adsorption of one or more chemical analytes. These materials may be capable of functionalizing the surface to adsorb molecules, such as proteins and the like. These materials may also be selectively applied to different elongated sidewalls to adsorb different chemicals. By so doing, a sensor having multiple elongated sidewalls may be capable of sensing many different analytes in a fluid, have complementary sensing for robustness or the ability to check results, and/or have redundancies for accuracy. In the illustrated embodiment, the materials comprise a coupling layer of 3-aminopropyltriethoxysilane linked with glutaraldehyde that tethers an aptamer capable of sensing a particular protein to the thermally grown silicon oxide dielectric surface of the elongated sidewalls 204. A number of alternative functionalization chemistries are suited to this purpose and are commonly used in the fields of DNA microarrays, protein chips, and silane coupling agents.

Channel housing 202 may be integrated into a sensing system. This sensing system may establish an appropriate electric field to create electrically activate channel regions 402. With an appropriate electric field, the active width of the channel region may be established in the nanometer-scale range based on a size of an inversion layer created at elongated sidewalls 204. Also, the cross-section of the channel regions may be substantially consistent along the length of the channel region. This consistency is related to the surface characteristics of the elongated sidewall and the electric field. The surface of the elongated sidewall may be made smooth and planar, as described above. The electric field may be made highly consistent across the length of the channel region, thereby enabling a consistent active width for the channel region. Alternatively, the cross-section of the active channel may instead be made to vary along the length of the channel region if a second electrical bias is applied between the source and drain.

In one embodiment, the sensing system comprises a reference electrode, measurement circuitry, a computer for analyzing changes to the electrical behavior of the channel region, fluidic structures for directing liquid or gaseous fluids over the elongated sidewalls, and the like (not shown). Said fluidic structures may be a well or micro-channel of a suitable material such as glass, various plastics, SU8, and the like. Said fluidic structures may be the membrane of a cell or a single-cellular organism. The sensing system may further comprise liquid or gaseous fluids that may contain a quantity of a chemical analyte, such as a protein species. The sensing system may comprise source and drain regions electrically connecting the channel region to the measurement circuitry. These source and drain regions may be formed integral with or as part of substrate 106 of FIG. 1 or may be added with further processing. In embodiments where the channel housing comprises doped silicon, the source and drain regions may comprise silicon doped effective to enable electrical communication between the source region and the drain region by electrical inversion of part of the channel housing (e.g., the electrically active channel region). For example, if the channel housing comprises N-doped silicon, the source region and the drain region may comprise P-doped silicon, and vice-a-versa.

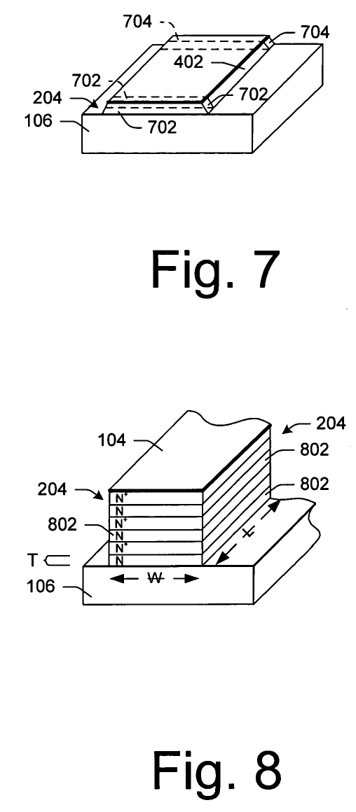

Referring to FIG. 7, a source region 702 and a drain region 704 are shown. These regions can comprise P-doped regions, such as region 108 shown in FIG. 1. These regions enable electrical communication with the sensing system and also help to enable an appropriate electric field to act near elongated sidewalls 204 to create channel regions 402.

Fabricating Stacked Channel Housings

In some embodiments, stacked channel housings may be fabricated; an exemplary process for this is set forth below.

Referring to FIG. 8, stacked channel housings 802 are shown over substrate 106 and under dielectric layer 104 after patterning. The patterning and other processing may be performed in any of the manners set forth relating to FIGS. 2 and 3 above. Each of the stacked channel housings may be formed by patterning semiconductive layers that are electrically isolated from each other. This electrical isolation may be enabled through insulative layers residing between the stacked semiconductive layers (not shown). In the illustrated embodiment, this electrical isolation is enabled through periodic doping of the semiconductive layers from which the stacked channel housings are patterned. Here each layer comprises silicon that is doped differently from its neighbors. The illustrated stacked isolation layers and channel housings are marked “N⁺” and “N” to denote heavy and moderate doping. The moderately doped “N” regions are active channels under conditions of applied external field where the heavily doped “N+” regions are not active.

Each of these stacked channel housings may have properties and dimensions similar to those described for the single channel housing and array of channel housings set forth for FIGS. 1-7 and FIG. 9. Thus, each of these stacked channel housings may comprise channel regions when subject to an appropriate electric field. These channel regions may have cross-sections and other properties similar to those set forth herein for the single and arrayed channel housings. In one embodiment, the stacked channel housings have elongated sidewalls 204 like those set forth above. These elongated sidewalls may be etched to create a nearly perfectly planar surface.

Also, these stacked channel housings may be oriented in a sensing system similar to those described above. The source and drain regions for these channel regions may be oriented to enable electrical communication with each of the channel housings or, alternatively, with a subset of the total (such as all the N doped layers).

Array of Channel Housings

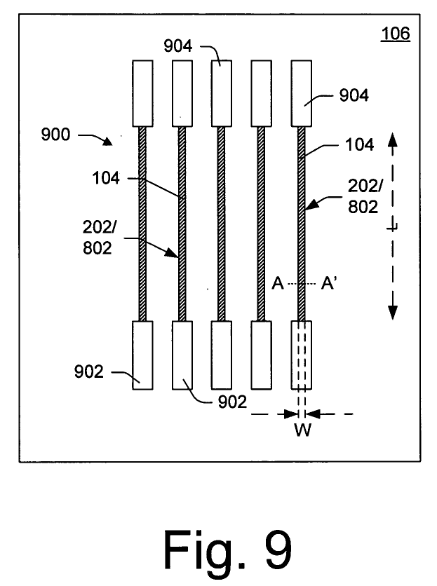

Referring to FIG. 9, a top plan view of an exemplary array 900 of channel housings 202 or stacked channel housings 802 is shown. Each of the channel housings or stacks of channel housings are shown in electrical communication with one of the source regions 902 and one of the drain regions 904. The array resides over substrate 106, and each of the channel housings and/or stacks of housings reside under dielectric layers 104. The substrate and the array may be oriented within the sensing system described above. Prior or subsequent to being placed in the sensing system, elongated sidewalls of the channel housings or stacks of channel housings may be processed to target particular chemicals. The cross-section along lines A to A′ is shown, depending on the embodiment, by FIG. 2, 3, 6, or 8. The width and length of one of channel housings 202/stacks of channel housings 802 are marked at “W” and “L”, respectively.

Although the invention is described in language specific to structural features and methodological steps, it is to be understood that the invention defined in the appended claims is not necessarily limited to the specific features or steps described. Rather, the specific features and steps disclosed represent preferred forms of implementing the claimed invention.

What is claimed:

1. A nanoscale chemically sensitive field-effect transistor comprising:
a source region;
a drain region; and
a channel housing, the channel housing having a length, width, and thickness, the thickness being nanometer in scale, wherein the channel housing comprises, when subject to an electric field, an electrically active channel region in electrical communication with the source region and the drain region and having an electrically active cross-section along the channel housing's length that is bounded by the channel housing's thickness and has an active width, the active width being nanoscale and dependent on the electric field's strength, and an electrically inactive channel region having an electrically inactive cross-section along the channel housing's length that is bordered by the electrically active channel region and has an inactive width greater than the active width of the electrically active channel region.

2. The chemically sensitive field-effect transistor of claim 1, wherein the channel housing comprises a surface through which alteration of the electric field's strength is capable of altering the active width of the electrically active channel region.

3. The chemically sensitive field-effect transistor of claim 2, wherein the surface is functionalized effective to enable adsorption of a specific chemical in general preference to other chemical types.

4. The chemically sensitive field-effect transistor of claim 2, wherein the surface extends along the channel housing's length and thickness and the electrically active channel region's length and height.

5. The chemically sensitive field-effect transistor of claim 2, wherein the surface is generally planar.

6. The chemically sensitive field-effect transistor of claim 5, wherein the surface comprises a {111} crystal plane of silicon.

7. The chemically sensitive field-effect transistor of claim 2, wherein the channel housing comprises a second surface extending along the channel housing's length and width, the second surface substantially incapable of enabling alteration of the height or active width of the electrically active channel region through alteration of the electric field's strength.

8. The chemically sensitive field-effect transistor of claim 7, wherein the second surface is electrically isolated by a low-capacitance layer.

9. The chemically sensitive field-effect transistor of claim 1, wherein the channel housing's length and width are micrometer or larger in scale.

10. The chemically sensitive field-effect transistor of claim 1, wherein the electrically active channel region's active width is capable of being nanometer or smaller in scale.

11. The chemically sensitive field-effect transistor of claim 1, wherein the electrically inactive channel region's inactive width is capable of being micrometer or larger in scale.

12. The chemically sensitive field-effect transistor of claim 1, wherein the source region and the drain region comprise doped silicon and the channel housing comprises silicon doped effective to enable electrical communication between the source region and the drain region by electrical inversion of the electrically active channel region.

13. The chemically sensitive field-effect transistor of claim 1, wherein the electrically active cross-section has a substantially consistent area along the length of the electrically active channel region.

14. The chemically sensitive field-effect transistor of claim 1, further comprising a dielectric layer overlaying the channel housing, the dielectric layer effective to electrically isolate a top surface of the channel housing.

15. The chemically sensitive field-effect transistor of claim 1, further comprising one or more other channel housings, the first channel housing and the other channel housing oriented in an array.

16. A system comprising:
a source region;
a drain region; and
a channel housing, the channel housing:
having a length and width of at least one micrometer and a thickness between about one and about 100 nanometers;
having a generally planar surface along at least a portion of the thickness and the length; and
capable of having an electrically active channel region oriented along the surface in electrical communication with the source region and the drain region when the surface is in an electric field of sufficient strength to create an inversion layer along the surface.

17. The system of claim 16, wherein a cross-section of the electrically active channel region perpendicular to the generally planar surface has a height dependent on the thickness of the channel housing and an active width between about one and about 10 nanometers when the generally planar surface is in the electric field.

18. The system of claim 16, wherein the generally planar surface comprises a (111) silicon crystal plane.

19. The system of claim 16, further comprising one or more other channel housings, the first channel housing oriented over a substrate and the other channel housings stacked over the first channel housing, all of the channel housings electrically isolated from each other, and each of the other channel housings:
having a length and width of at least one micrometer and a thickness between about one and about 100 nanometers;
having a generally planar surface along at least a portion of the length that is generally planar; and
capable of having an electrically active channel region oriented along the generally planar surface when the generally planar surface is in an electric field of sufficient strength to create an inversion layer along the generally planar surface.

20. The system of claim 19, wherein each channel housing is electrically isolated from neighboring first or other channel housings by a differently doped layer.

21. The system of claim 16, further comprising one or more other channel housings, the first channel housing and the other channel housings oriented as an array and over a substrate.

22. The system of claim 21, further comprising additional source regions and additional drain regions, wherein each of the other channel housings:
have a length and width of at least one micrometer and a thickness between about one and about 100 nanometers;
have a generally planar surface along at least a portion of the length that is generally planar; and
is capable of having an electrically active channel region oriented along the generally planar surface in electrical communication with one of the additional source regions and one of the additional drain regions when the generally planar surface is in an electric field of sufficient strength to create an inversion layer along the generally planar surface.

23. A method comprising:
patterning a semiconductive layer having a thickness between about one and about 100 nanometers effective to create a channel housing from the layer that has approximately the layer's thickness, a micrometer-scale length and width, and a generally planar surface along at least a portion of the length and thickness of the channel housing; and
applying one or more materials on the generally planar surface effective to enable adsorption of a chemical.

24. The method of claim 23, further comprising, prior to the act of applying, chemically etching the channel housing effective to make the generally planar surface.

25. The method of claim 23, wherein the act of patterning comprises patterning multiple stacked semiconductive layers, each of the layers having a thickness between about one and about 100 nanometers, the act of patterning effective to create additional channel housings from each of the layers that has about that layer's thickness, a micrometer-scale length and width, and a generally planar surface along at least a portion of that channel housing's length and thickness.

26. The method of claim 25, further comprising orienting two or more of the channel housings into electrical communication with one source region and one drain region. [instead: with source and drain regions. ???]

27. A method comprising:
patterning a semiconductive layer having a thickness between about one and about 100 nanometers effective to create an array of channel housings from the layer, each of the channel housings having about the layer's thickness, a micrometer-scale length and width, and a generally planar surface along at least a portion of the length and thickness; and
applying one or more materials on the generally planar surface of the channel housings effective to enable adsorption of one or more chemicals.

28. The method of claim 27, further comprising, prior to the act of applying the materials, chemically etching the channel housings effective to make the generally planar surface.

29. The method of claim 27, wherein the semiconductive layer comprises three regions having silicon, the first region in electrical proximity to the second region and the second region in electrical proximity to the third region, the first region and the third region's silicon being oppositely doped from the second region's silicon.

30. The method of claim 29, wherein the act of patterning comprises patterning channel housings from the second region, source regions from the first region, and drain regions from the third region.

31. The method of claim 30, wherein the act of patterning electrically separates each of the source regions.
